(19) United States
(12) Patent Application Publication
(10) Pub. No.: US 2014/0190986 A1
(43) Pub. Date: Jul. 10, 2014

(54) DRUG RETRIEVAL DEVICE

(71) Applicant: Hideyuki Kikuchi, Hirakata-shi (JP)

(72) Inventor: Hideyuki Kikuchi, Hirakata-shi (JP)

(73) Assignee: TAKAZONO TECHNOLOGY INCORPORATED, Hirakata-shi, Osaka (JP)

(21) Appl. No.: 14/238,512

(22) PCT Filed: Aug. 22, 2012
(86) PCT No.: PCT/JP2012/071169

§ 371 Date: Feb. 12, 2014

(30) Foreign Application Priority Data
Sep. 5, 2011 (JP) 2011-192798

(51) Int. Cl. A61J 7/00

(52) U.S. Cl. CPC A61J 7/0076
USPC 221/277

(57) ABSTRACT

A drug dispensing device capable of preventing clogging of a drug is provided. The drug retrieval device includes a motor, a torque limiter connected to the motor, and a rotor of a cassette connected to the torque limiter. The motor can rotate the rotor in a first rotation direction and a second rotation direction opposite to the first rotation direction.

### TECHNICAL FIELD

The present invention relates to a drug retrieval device, and more particularly to a drug retrieval device for retrieving a tablet.

### BACKGROUND ART

Conventionally, drug retrieval devices have been disclosed in, for example, WO2001/060726 (PTD 1) and WO2003/042042 (PTD 2).

PTD 1 discloses a configuration of reversely rotating a motor in the case where discharge detection means does not detect drug discharging in a normal state even when the motor is rotated to discharge a drug.

PTD 2 discloses a configuration of blocking motive power from a motor by means of a power blocking unit when braking force of greater than or equal to a predetermined value is exerted to a rotor.

### CITATION LIST

### Patent Document

PTD 1: WO2001/060726
PTD 2: WO2003/042042

### SUMMARY OF INVENTION

### Technical Problem

According to PTD 1, there is a case where a drug clogs tightly. In such a case, clogging of the drug cannot be resolved even by a reverse rotation of the motor.

Further, according to PTD 2, although tight clogging of the drug can be avoided, clogging of the drug cannot be resolved.

In view of the above, the present invention was achieved to solve the problems described above, and its object is to provide a drug retrieval device capable of resolving clogging of a drug assuredly.

### Solution to Problem

A drug retrieval device according to one aspect of the present invention includes a rotation power source, a torque limiter connected to the rotation power source to limit transmission of rotating force when the rotating force transmitted from the rotation power source exceeds a predetermined value, and a rotor connected to the torque limiter to be rotatable and being capable of retrieving a drug by rotation. The rotor is rotatable in a first rotation direction and a second rotation direction opposite to the first rotation direction.

A drug retrieval device according to another aspect of the invention includes a rotation power source, and a torque limiter connected to the rotation power source to limit transmission of rotating force when the rotating force transmitted from the rotation power source exceeds a predetermined value. The torque limiter is connected to a rotor capable of retrieving a drug by rotation, and the rotor is rotatable in a first rotation direction and a second rotation direction opposite to the first rotation direction.

Since the torque limiter is provided in the drug retrieval device with such a configuration, the rotor does not rotate when a rotational resistance of the rotor becomes greater due to clogging of a drug. Therefore, clogging of a drug can be reduced. Further, since the rotor is rotated in a reverse direction in the case of clogging, clogging of a drug can be resolved.

Preferably, rotation speeds of the rotor in the first direction and the second directions can be changed.

Preferably, a rotation speed in the first rotation direction is faster than a rotation speed in the second rotation direction.

Preferably, the rotor is rotated in the first rotation direction for a first time period, and thereafter rotated in the second rotation direction for a second time period.

Preferably, when a drug is not retrieved by rotation of the rotor in the first rotation direction, the rotor is rotated in the second rotation direction.

### BRIEF DESCRIPTION OF DRAWINGS

FIG. 1 is a perspective view representing a drug retrieval device to which a cassette is mounted according to a first embodiment of the present invention.

FIG. 2 is a perspective view representing a state where the cassette is removed from the drug retrieval device shown in FIG. 1.

FIG. 3 is a cross-sectional view representing the drug retrieval device taken along arrow lines in FIG. 2.

FIG. 4 is a perspective view representing a cassette base mounted to the drug retrieval device according to the first embodiment.

FIG. 5 is a cross-sectional view representing a state where the cassette base including a motor and a torque limiter is engaged with the cassette.

FIG. 6 is a perspective view representing a power transmission path including the motor, gears, and the torque limiter in the cassette base.

FIG. 7 is a perspective view representing the drug retrieval device in a state where a front panel is opened so that a hopper is exposed.

FIG. 8 is an exploded perspective view representing a state where a hopper for guiding a drug is separated from a hopper retaining member.

FIG. 9 is a perspective view representing a configuration of a shutter in the drug retrieval device from which the hopper is removed.

FIG. 10 is a perspective view representing the shutter and the drug retrieval device viewed from a direction indicated by an arrow X in FIG. 9.

FIG. 11 is an exploded perspective view representing an upper plate, a lower plate, a shutter guide, and a cassette guide to describe assembling procedures of the shutter.

FIG. 12 is a perspective view representing a final step in the assembling procedures of the shutter.

FIG. 13 is a side view of a part surrounded by the circle XIII in FIG. 12, representing a connection portion between a screw screwed to the lower plate and a coil spring engaged with the upper plate.

FIG. 14 is a bottom view representing the assembled shutter.

FIG. 15 is a perspective view representing the cassette to describe configurations of the gear and a locked portion.

FIG. 16 is a side view representing the drug retrieval device to describe an engaged state between the cassette guide and the cassette.

FIG. 17 is a cross-sectional view representing the drug retrieval device and the cassette corresponding to FIG. 16.

FIG. 18 is a side view of the drug retrieval device representing a state where a drug is supplied to the cassette to which a cover member is attached.

FIG. 19 is a cross-sectional view of the drug retrieval device and the cassette corresponding to FIG. 18.

FIG. 20 is a perspective view representing the cover member.

FIG. 21 is a circuit diagram of the drug retrieval device according to the embodiment.

FIG. 22 is a block diagram representing a configuration of the drug retrieval device according to the embodiment.

FIG. 23 is a flowchart representing drug retrieval operation of the drug retrieval device according to a first example.

FIG. 24 is a flowchart representing a flow of allowing the rotor of the cassette to perform a normal rotation and a reverse rotation.

FIG. 25 is a flowchart representing drug retrieval operation of the drug retrieval device according to a second example.

### DESCRIPTION OF EMBODIMENTS

Hereinafter, embodiments of the present invention will be described with reference to the drawings. In the following embodiments, the same or corresponding parts have the same reference numerals allotted, and description thereof will not be repeated. Further, embodiments can also be combined.

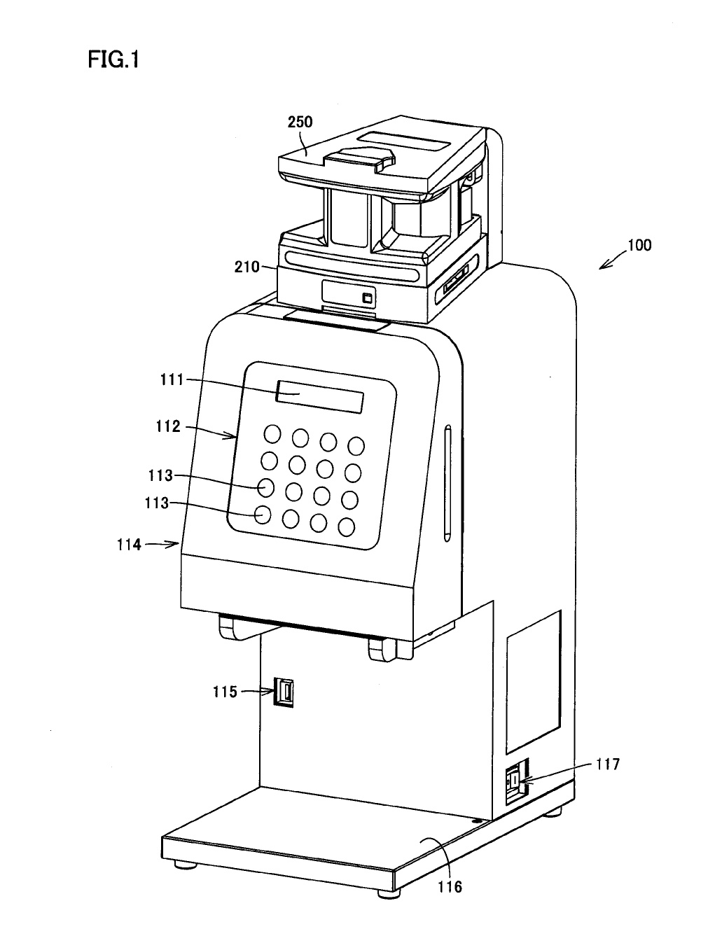

FIG. 1 is a perspective view representing a drug retrieval device to which a cassette is mounted according to a first embodiment of the present invention. Referring to FIG. 1, a drug retrieval device 100 as a drug counter includes a front panel 114. Front panel 114 is provided with an operation panel. The operation panel is provided with a display portion 111 and an input portion 112. Display portion 111 displays information such as the number of counted drugs. Input portion 112 is provided with a plurality of keys 113, and an operator can operate drug retrieval device 100 with use of keys 113.

A USB terminal 115, a base 116, and a power switch 117 are arranged in a lower portion of drug retrieval device 100. A memory can be connected to USB terminal 115. Base 116 is a portion on which a container for receiving a drug to be dispensed from drug retrieval device 100. Power switch 117 is a location for turning on and off power supplied to drug retrieval device 100.

A cassette 250 is engaged with a cassette base 210. A drug is stored in cassette 250. In cassette 250, a rotor is provided. The drug can be retrieved from the cassette by rotation of the rotor.

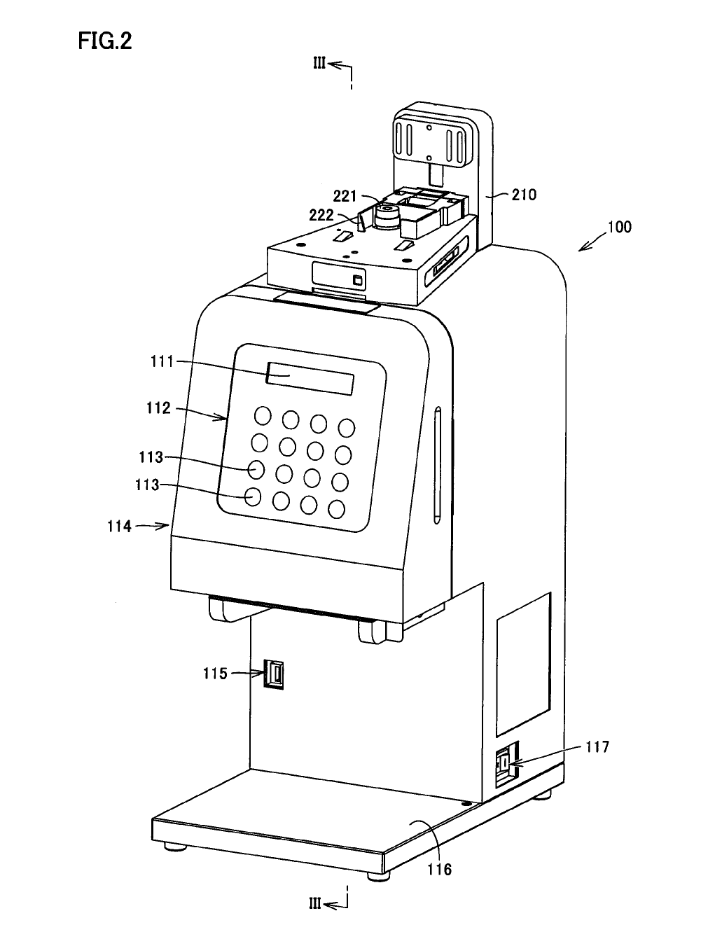

FIG. 2 is a perspective view representing a state where the cassette is removed from the drug retrieval device shown in FIG. 1. Referring to FIG. 2, in the state where cassette 250 is not attached, a gear 221 is exposed on cassette base 210. A guiding portion 222 is a member for guiding cassette 250. Gear 221 constitutes a power transmission portion transmitting power for rotating the rotor in cassette 250.

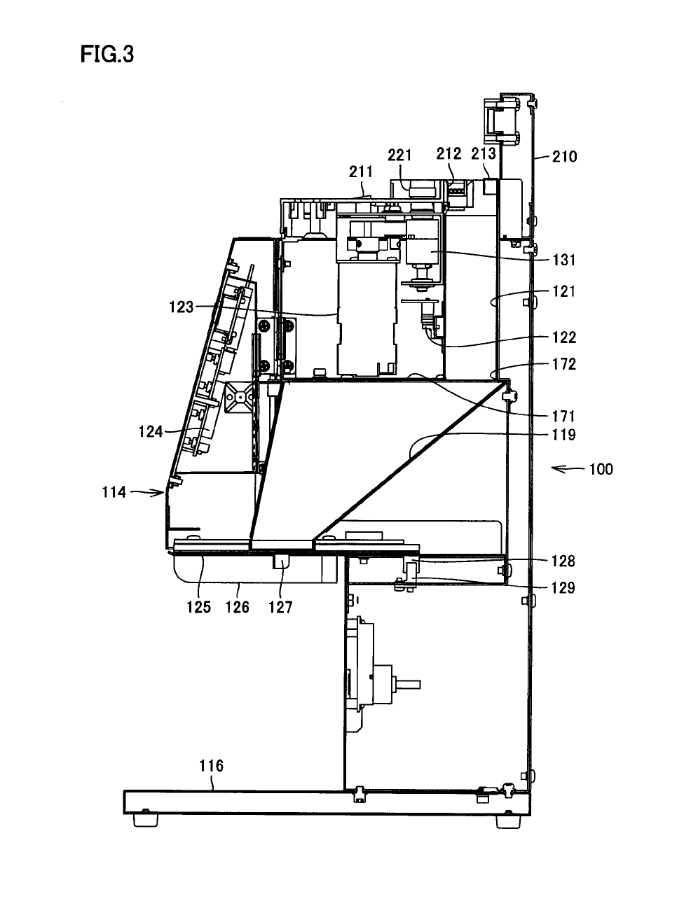

FIG. 3 is a cross-sectional view representing the drug retrieval device taken along arrow lines in FIG. 2. Referring to FIG. 3, cassette base 210 is attached on an upper portion of drug retrieval device 100. In cassette base 210, a pressed portion 213 is provided. By pressing pressed portion 213, a chute 121 for guiding a drug downward can be detached from a chute retaining portion 122.

Cassette base 210 is provided with a drug detection sensor 212. Drug detection sensor 212 can detect a drug passing in front of drug detection sensor 212. Locking claws 211 are attached to cassette base 210. Locking claws 211 engage with cassette 250 to prevent dislocation of cassette 250.

A motor 123, a torque limiter 131, and a gear 221 are arranged on a power transmission path for driving the cassette.

Motor 123 is a rotation power source for rotating the rotor, and the rotor can be rotated in a normal rotation direction, which is a first rotation direction, and a reverse rotation direction, which is a second rotation direction opposite to the first rotation direction. Motor 123 is controlled by controller 800 described later so as to allow the rotor to perform the normal rotation and the reverse rotation.

Rotating force transmitted from motor 123 is delivered to gear 221 via torque limiter 131.

Torque limiter 131 is a mechanism for restricting torque of rotating force transmitted from motor 123. Torque limiter 131, which is a power blocking portion, lies on a power transmission path between the rotor and motor 123, and blocks power from motor 123 when torque exceeding set torque is generated between the rotor and motor 123.

On a back side of front panel 114, a circuit board 124 is provided. Information inputted from input portion 112 provided on front panel 114 is processed by a computer in circuit board 124.

In a central portion of drug retrieval device 100, a hopper 119 is provided. Chute 121 is located on an upstream side of hopper 119, and a shutter 125 is arranged on a downstream side of hopper 119.

Shutter 125 is a member for permitting and prohibiting downward falling of a drug from hopper 119. Under shutter 125, the cassette is placed on base 116, and the drug in hopper 119 can be delivered to the cassette by opening shutter 125.

In the vicinity of shutter 125, there are provided a cassette guide 126 and a pressed portion 127. Movement of shutter 125 is detected by a detected portion 128 and a shutter detection sensor 129. For example, operation of not counting in a situation where shutter 125 is opened to allow the drug to falls from hopper 119 can be controlled.

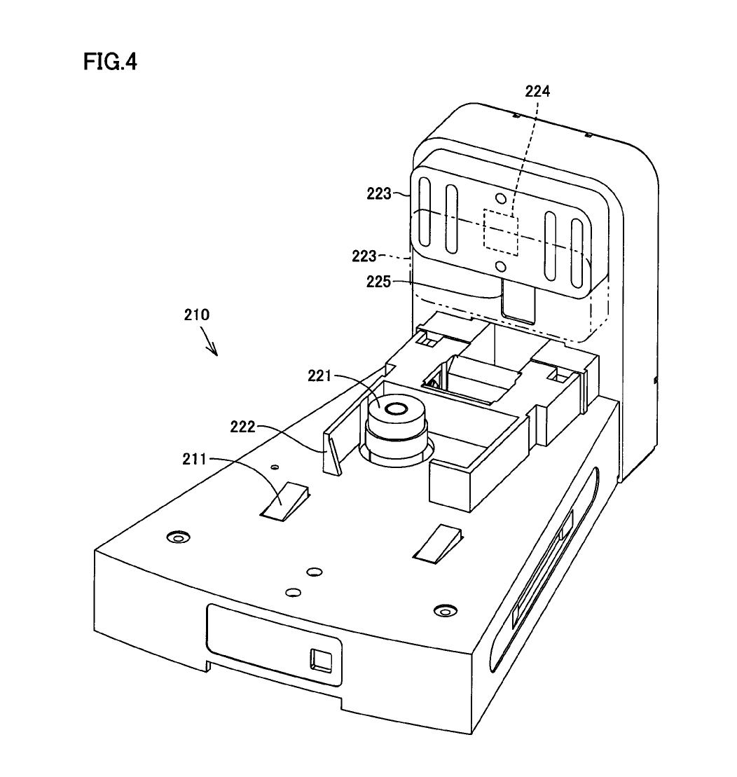

FIG. 4 is a perspective view representing the cassette base mounted to the drug retrieval device according to the first embodiment. Referring to FIG. 4, cassette base 210 is provided with a cassette retaining portion 223. A permanent magnet 224 is provided in cassette retaining portion 223. Cassette 250 can be retained by permanent magnet 224. Cassette retaining portion 223 is slidable to a lower side as indicated by two-dot chain lines in FIG. 4. The amount of sliding is adjusted by an elongated hole 225. Cassette retaining portion 223 is rendered vertically slidable, so that cassette retaining portion 223 can be positioned at a position adapted to the shape and dimension of the cassette.

Gear 221 is rotated integrally with a shaft connected to the torque limiter so as to perform the normal rotation and the reverse rotation. Providing locking claws 211 can prevent dislocation of the cassette from cassette base 210 even when gear 221 performs the normal rotation and the reverse rotation.

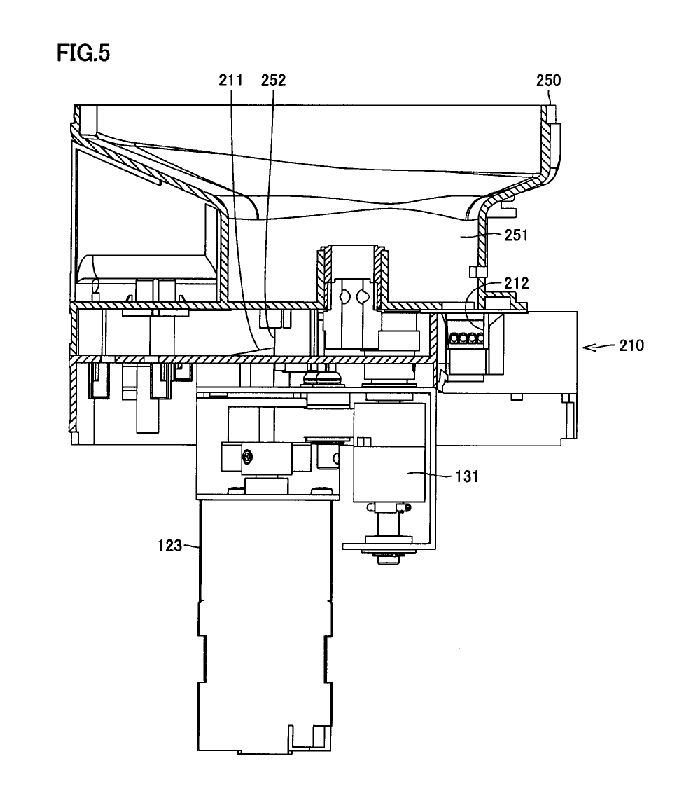

FIG. 5 is a cross-sectional view representing a state where the cassette base including the motor and the torque limiter is engaged with the cassette. Referring to FIG. 5, locking claws 211 and locked portions 252 are in mesh with each other at the engagement portion. Accordingly, dislocation of cassette 250 from cassette base 210 can be prevented. The rotation power transmitted from motor 123 is transmitted to torque limiter 131. Torque limiter 131 is connected with rotor 251 via a gear. Rotation of rotor 251 allows a drug stored in cassette 250 to be discharged downward through drug detection sensor 212.

Motor 123 can transmit the rotating force of the normal rotation and the reverse rotation to rotor 251. In either direction of rotation, the engagement of locking claws 211 with locked portions 252 can prevent disengagement of cassette 250 from cassette base 210.

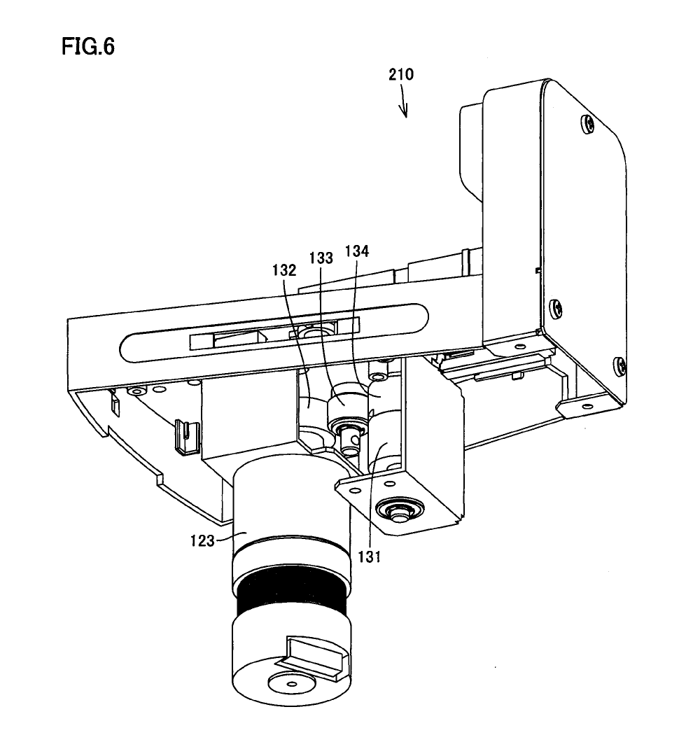

FIG. 6 is a perspective view representing a power transmission path including the motor, gears, and the torque limiter in the cassette base. Referring to FIG. 6, the rotation power of motor 123 is transmitted to a gear 132. This gear 132 is rotated integrally with an output shaft of motor 123. Gear 132 is in mesh with another gear 133. This intermediate gear 133 is arranged so as to be freely rotatable with respect to the shaft. Gear 133 is in mesh with another gear 134. Gear 134 is integrally rotated with an outer race member of torque limiter 131. An inner race member of torque limiter 131 is rotated integrally with an output shaft. A torque generating member (coil spring) lies between the inner race member and the outer race member of torque limiter 131. The coil spring is provided so as to cause friction with respect to an outer peripheral surface of the inner race member. During the rotation in the normal and reverse directions, application of torque exceeding set torque causes slipping between the inner race member and the outer race member, thereby blocking the transmission of power.

It is not always necessary to provide intermediate gear 133. Intermediate gear 133 may be omitted, and the configuration may be employed in which gear 132 integrally rotated with the output shaft of motor 123 is in mesh with gear 134 integrally rotated with the outer race member of torque limiter 131. Further, all of three gears 132, 133, and 134 may be omitted, and the output shaft of motor 132 may be integrally rotated with the outer race member of torque limiter 131.

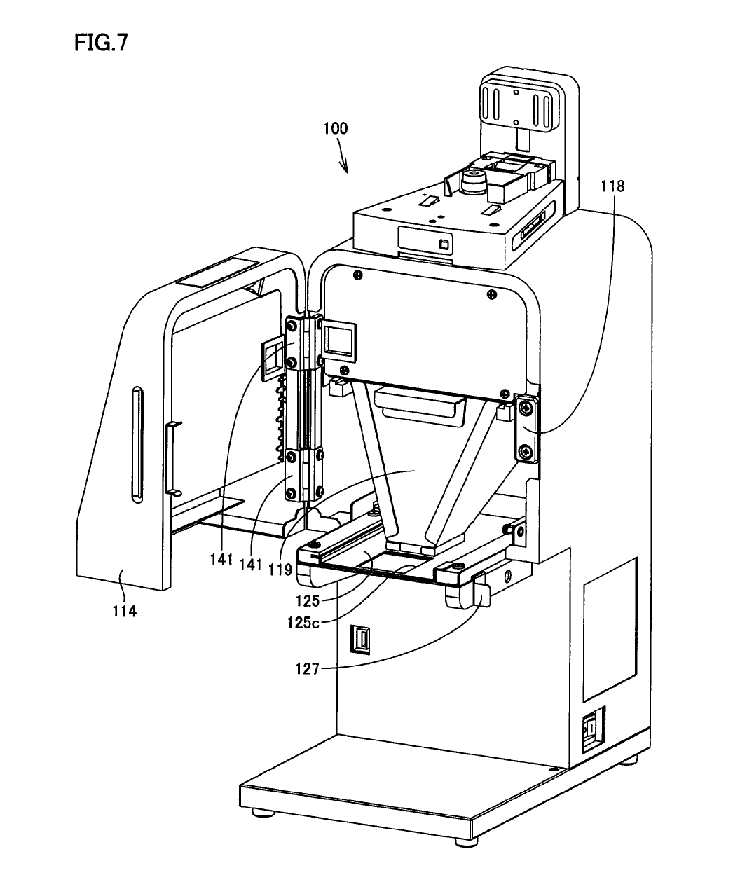

FIG. 7 is a perspective view representing the drug retrieval device in a state where the front panel is opened so that the hopper is exposed. Referring to FIG. 7, front panel 114 is attached to the main body by means of a hinge 141. The rotational axis of hinge 141 extends in the vertical direction so that front panel 114 is not closed by its own weight.

When front panel 114 is opened, hopper 119 and magnet 118 in drug retrieval device 100 are exposed. Magnet 118 can attract front panel 114 by magnetic force.

Shutter 125 is located under hopper 119, and opening 125c has such a shape to be slidable to the side of an opening of hopper 119.

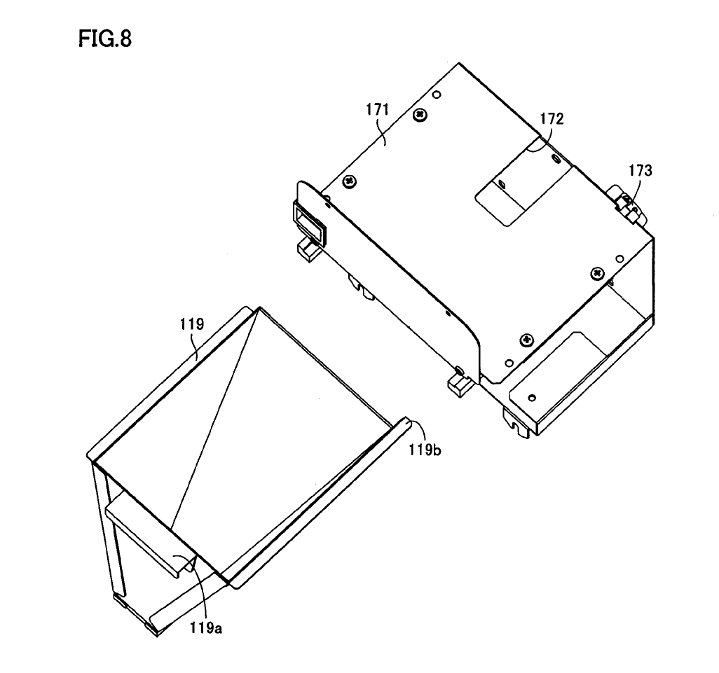

FIG. 8 is an exploded perspective view representing a state where the hopper for guiding a drug is separated from the hopper retaining member. Referring to FIG. 8, hopper 119 has a held portion 119a. Hopper 119 can be detached from drug retrieval device 100 by drawing held portion 119a.

Hopper 119 is retained by hopper retaining member 171. An opening 172 of hopper retaining member 171 is in communication with chute 121. Hopper detection sensor 173 is provided at hopper retaining member 171. A detected part 119b of hopper 119 is detected by hopper detection sensor 173, so that positioning of hopper 119 at a normal location is identified. In the case where positioning of hopper 119 at the normal location is not identified, counting of a drug can be refrained from starting.

Hopper 119 may be partially or totally transparent. This allows an operator to confirm whether or not a drug is present in hopper 119 by only opening front panel 114. In this case, it is not necessary to detach hopper 119 from drug retrieval device 100.

As another example, additionally, lighting may be provided above hopper 119, shutter 125 may be transparent, and a mirror may be provided on an upper surface of base 116. This allows an operator to confirm whether or not a drug is present in hopper 119 without opening front panel 114.

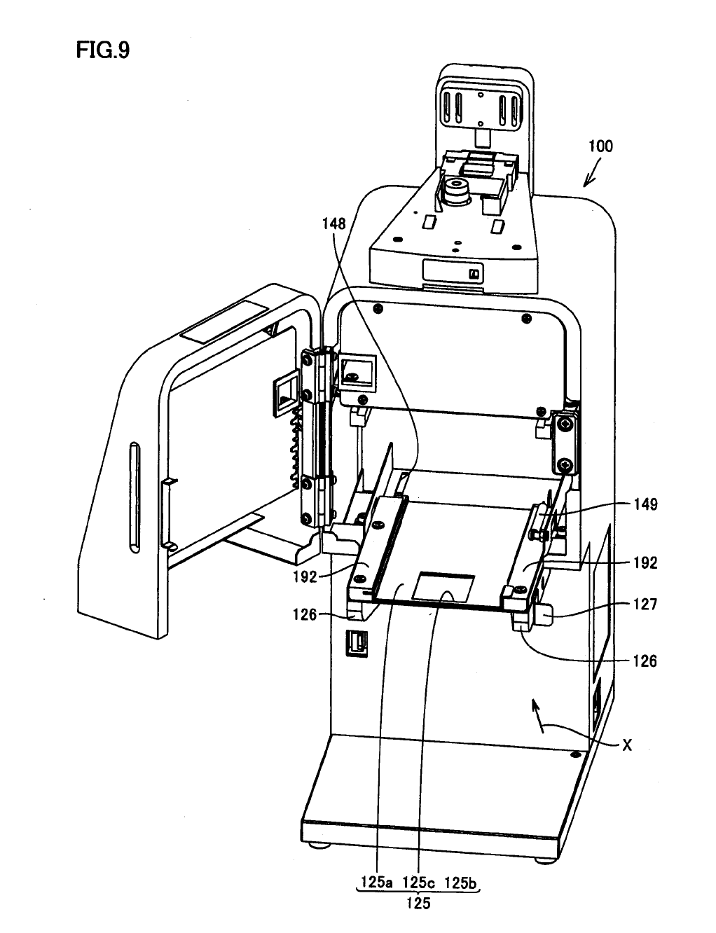

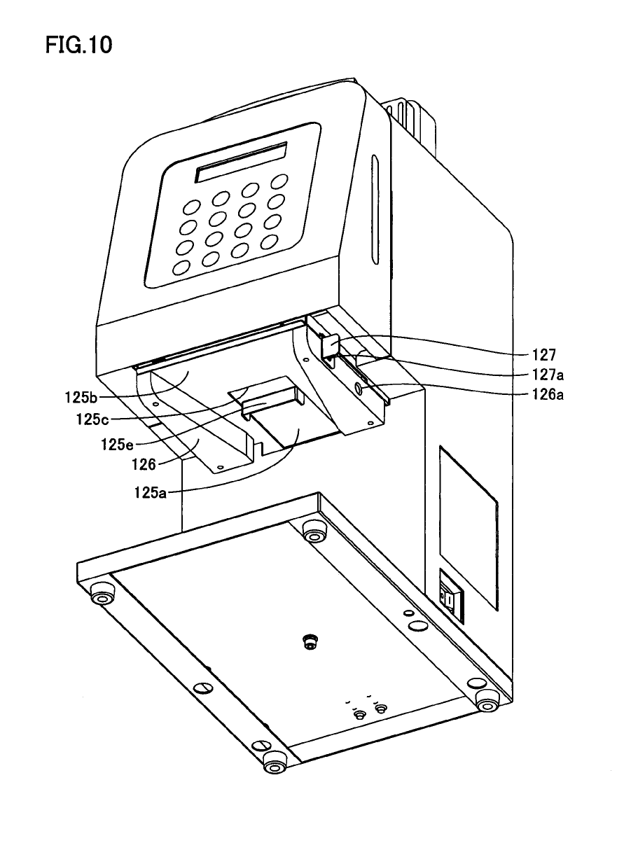

FIG. 9 is a perspective view representing a configuration of the shutter in the drug retrieval device from which the hopper is removed. FIG. 10 is a perspective view representing the shutter and the drug retrieval device viewed from a direction indicated by an arrow X in FIG. 9. Referring to FIGS. 9 and 10, shutter 125 has an upper plate 125a and a lower plate 125b. Upper plate 125a and lower plate 125b have opening 125c.

Lower plate 125b has an elongated hole 148, and detected portion 128 (FIG. 3) extends through elongated hole 148.

Upper plate 125a of shutter 125 is biased by a coil spring 149. When an operator presses pressed portion 127 by hand, coil spring 149 extends. When the pressing is stopped, contraction force of coil spring 149 allows upper plate 125a to return to the position shown in FIG. 9.

Cassette guides 126 are provided under lower plate 125b. Upper plate 125a is provided with a pressed portion 125e. By pressing pressed portion 125e with the cassette, opening 125c is opened, so that a drug can fall.

Further, cassette guide 126 has an insertion hole 126a, and pressed portion 127 has a through hole 127a. In a state where through hole 127a and insertion hole 126a are aligned, a pin can be inserted to insertion hole 126a via through hole 127a. Accordingly, an opened state of opening 125c of shutter 125 can be maintained.

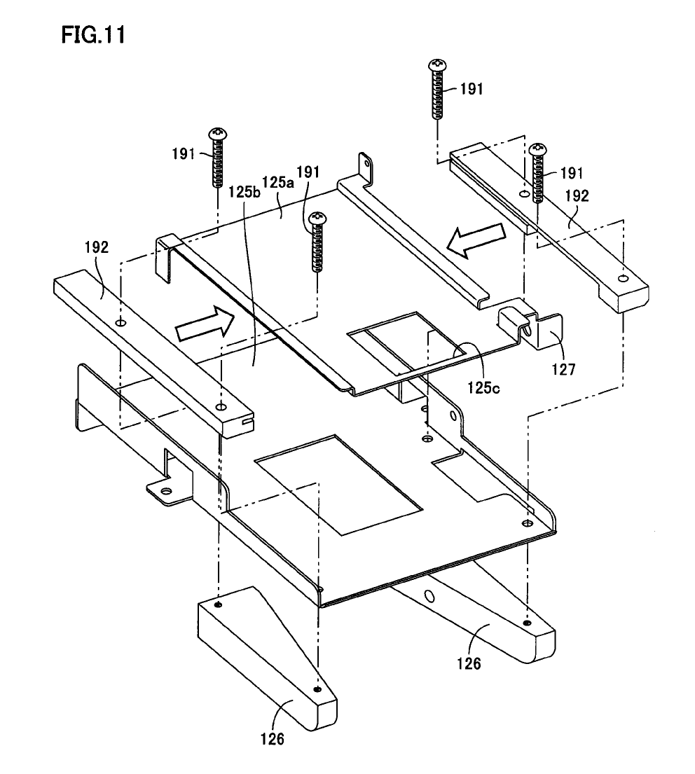

FIG. 11 is an exploded perspective view representing the upper plate, lower plate, shutter guide, and cassette guide to describe assembling procedures of the shutter. Referring to FIG. 11, upper plate 125a, lower plate 125b, shutter guides 192, and cassette guides 126 constituting the shutter are fastened by bolts 191. Shutter guides 192 fit over upper plate 125a from the lateral sides of upper plate 125a.

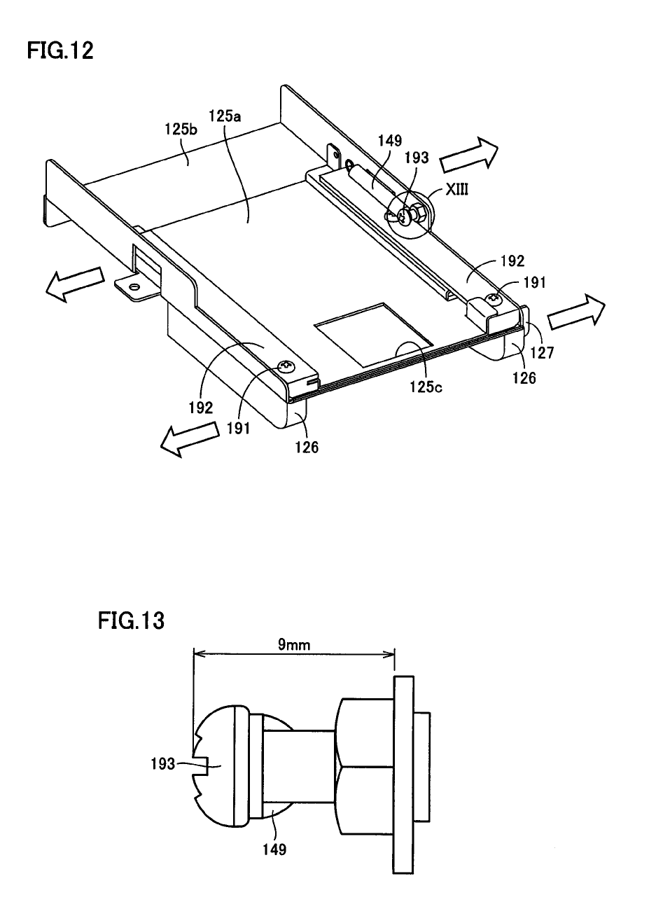

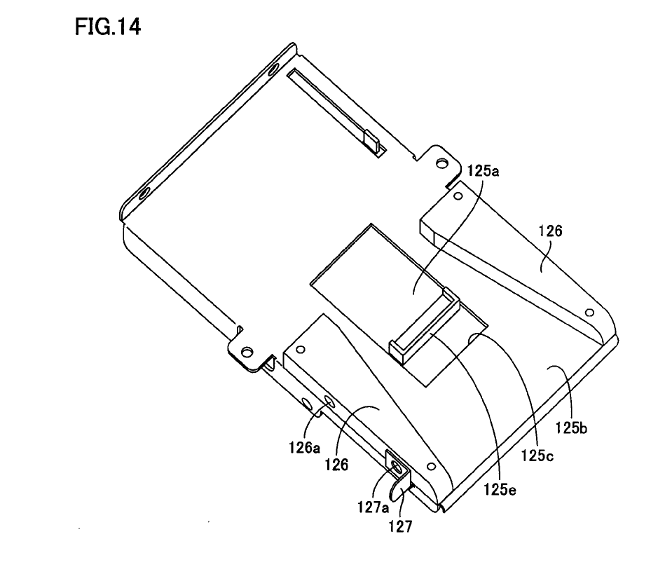

FIG. 12 is a perspective view representing a final step in the assembling procedures of the shutter. FIG. 13 is a side view of a part surrounded by the circle XIII in FIG. 12, representing a connection portion between a screw screwed to the lower plate and the coil spring engaged with the upper plate. FIG. 14 is a bottom view representing the assembled shutter. Referring to FIG. 12, in the final step, cassette guides 126 are pulled in the directions indicated by arrows to position cassette guides 126. Referring to FIG. 13, coil spring 149 is engaged with an end portion of upper plate 125a, and also engaged with a screw 193. Accordingly, coil spring 149 can be positioned. Referring to FIG. 14, pressed portion 125e projects downward, and opening 125c is opened by pressing pressed portion 125e in a rearward direction.

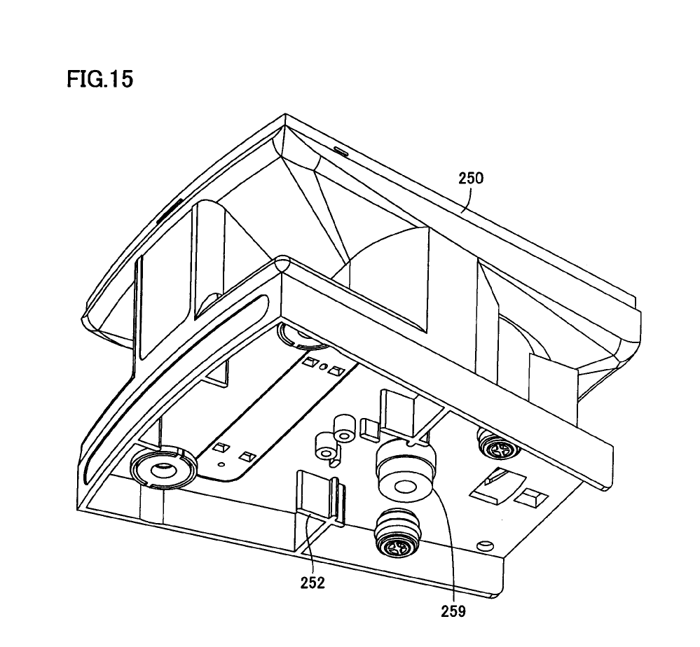

FIG. 15 is a perspective view representing the cassette to describe configurations of a gear and locked portions. Referring to FIG. 15, cassette 250 has a gear 259. Rotation of gear 259 allows rotation of the rotor in cassette 250. Locked portions 252 engage with locking claws 211 shown in FIG. 5.

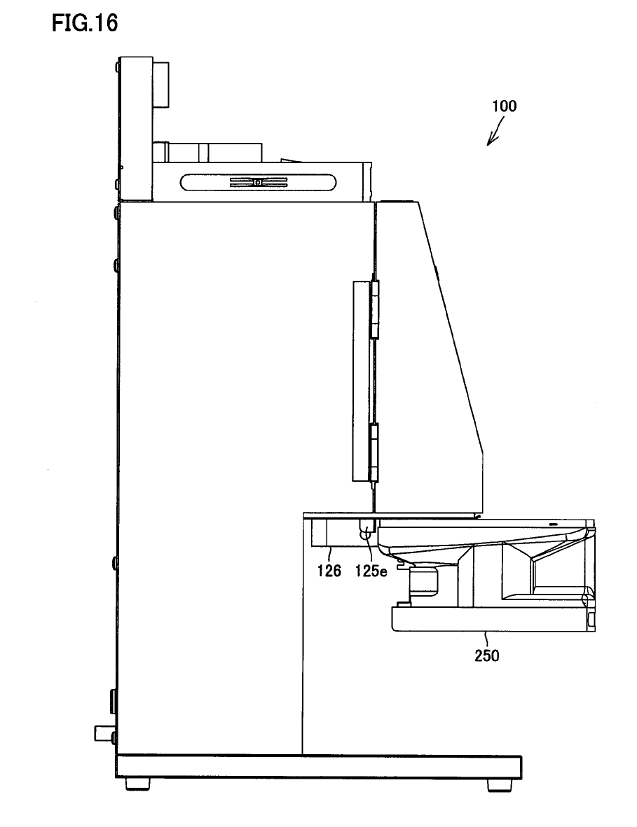

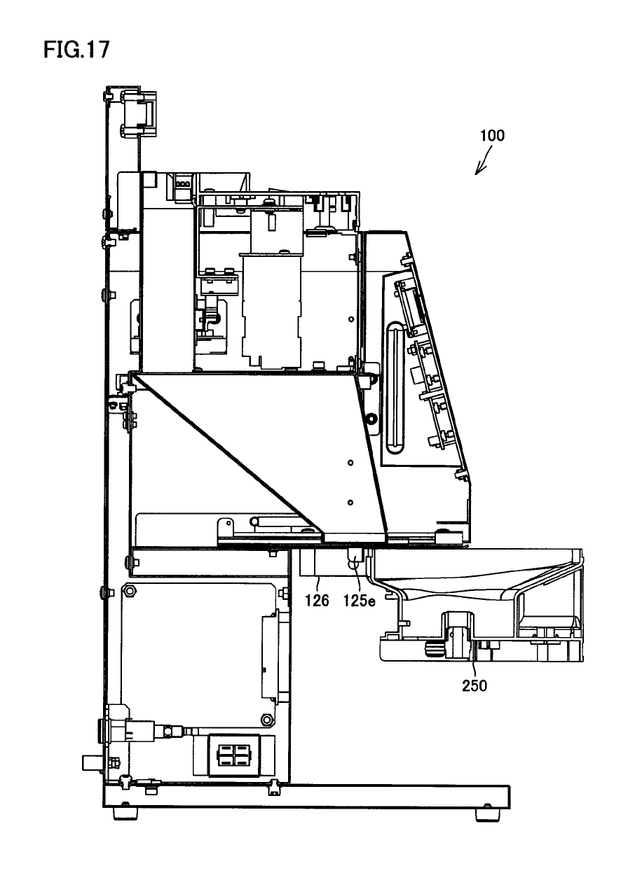

FIG. 16 is a side view representing the drug retrieval device to describe an engaged state between the cassette guide and the cassette. FIG. 17 is a cross-sectional view representing the drug retrieval device and the cassette corresponding to FIG. 16. Referring to FIGS. 16 and 17, in this embodiment, the amount of downward projection of pressed portion 125e is smaller than that of cassette guides 126. Therefore, as shown in FIGS. 16 and 17, cassette 250 presses pressed portion 125e only when cassette 250 fits between two cassette guides 126, so that the shutter can be opened. When the amount of downward projection of pressed portion 125e is greater than the amount of downward projection of cassette guides 126, cassette 250 may possibly press pressed portion 125e even in the case where cassette 250 does not fit between two cassette guides 126. In this case, the shutter may possibly be opened in the state where cassette 250 is misaligned. However, such danger can be prevented with drug retrieval device 100 according to the embodiment.

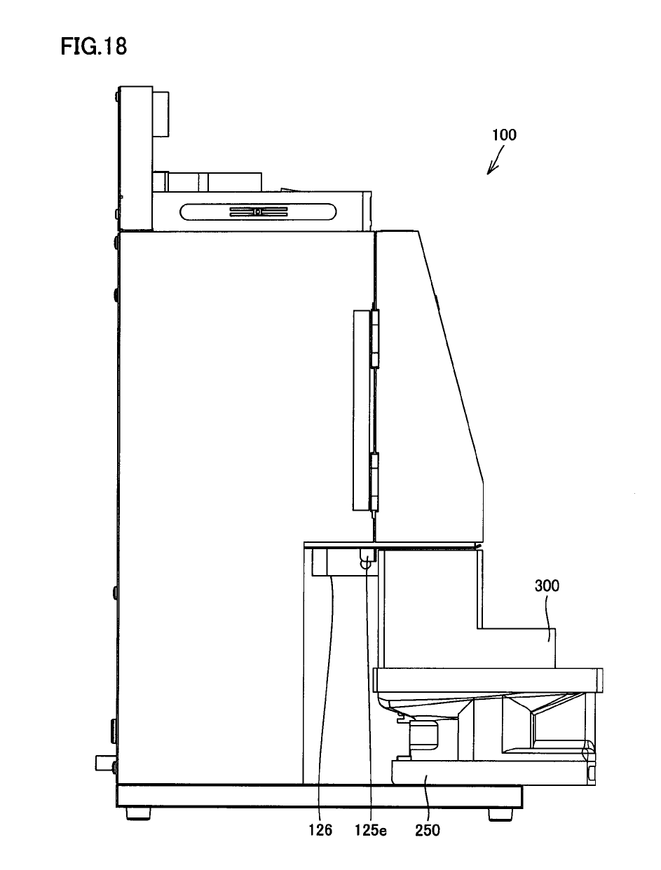

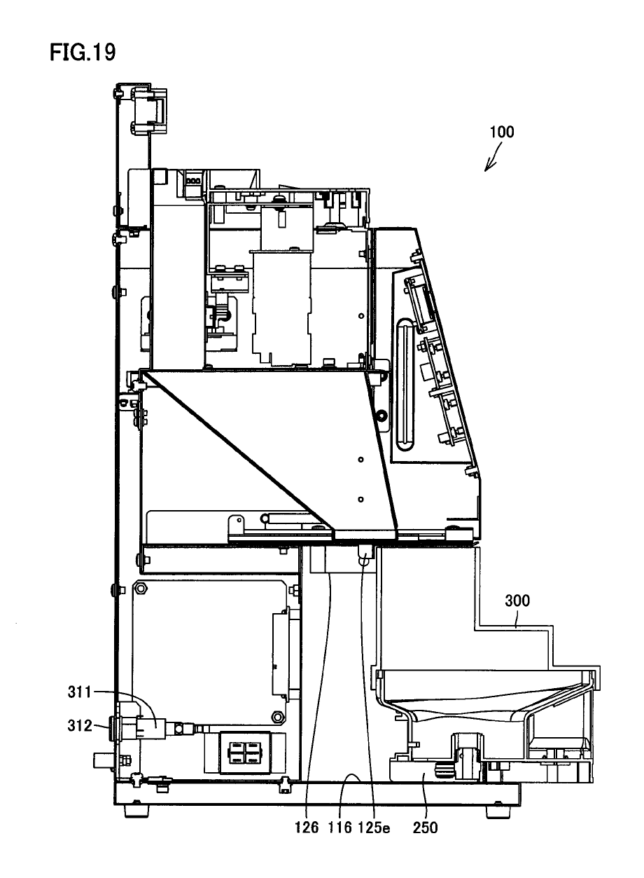

FIG. 18 is a side view of the drug retrieval device representing a state where a drug is supplied to the cassette to which a cover member is attached. FIG. 19 is a cross-sectional view of the drug retrieval device and the cassette corresponding to FIG. 18. Referring to FIGS. 18 and 19, when maintaining the state of cassette 250 pressed against the shutter is not desired, a cover member 300 is provided on cassette 250. In this case, cassette 250 is mounted on the upper surface of base 116, and cassette 250 can be positioned at the position shown in FIGS. 18 and 19 by only moving cassette 250 horizontally. Bouncing of a drug can be prevented by providing cover member 300.

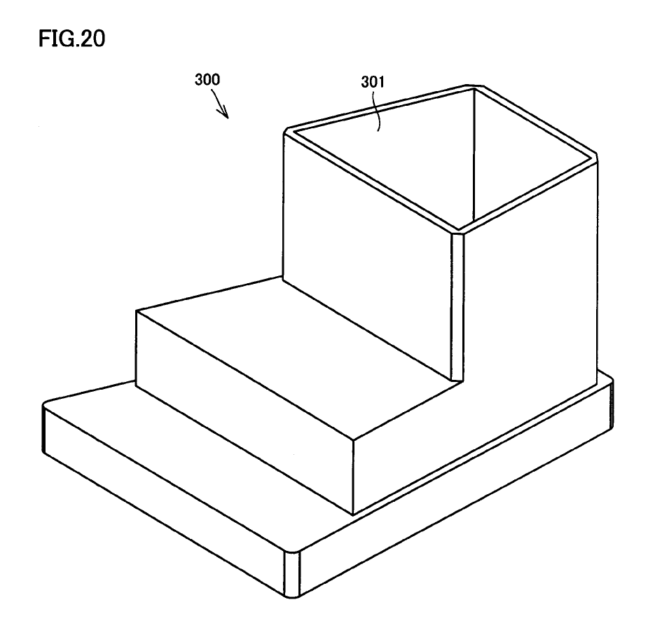

FIG. 20 is a perspective view representing the cover member. Referring to FIG. 20, cover member 300 has an opening 301. Opening 310 faces with the shutter, so that a drug discharged from the shutter is delivered to cassette 250 through opening 301.

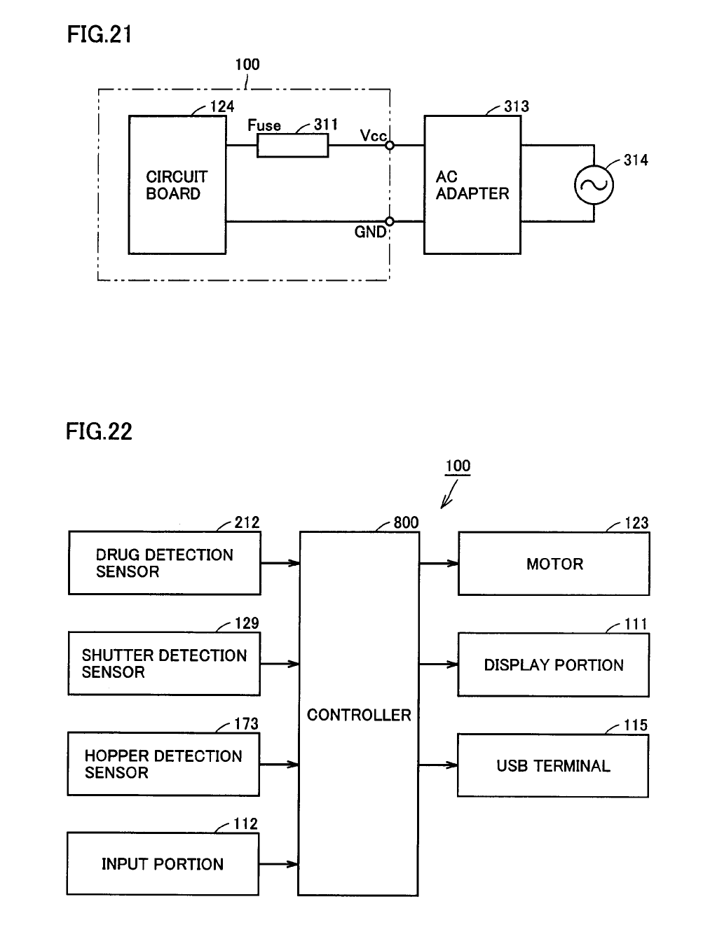

FIG. 21 is a circuit diagram of the drug retrieval device according to the embodiment. Referring to FIG. 21, drug retrieval device 100 has a circuit board 124 and a fuse 311 connected to circuit board 124. Fuse 311 is fused when overcurrent flows, thereby protecting circuit board 124. Fuse 311 is incorporated in the main body and connected to an adapter receiving portion 312 as shown in FIG. 19. Even when an AC adapter 313 for supplying power from a power supply 314 to circuit board 124 fails, or when another AC adapter is connected incorrectly, circuit board 124 can be protected by fusing of fuse 311.

When an AC adapter 313 having a protection circuit is used, it is not necessary to provide fuse 311. However, when fuse 311 is incorporated as described above, circuit board 124 can be protected regardless of a specification of the AC adapter, in other words, even if an AC adapter not provided with a protection circuit is used.

FIG. 22 is a block diagram representing a configuration of the drug retrieval device according to the embodiment. Drug retrieval device 100 has drug detection sensor 212 for detecting a falling drug, shutter detection sensor 129 for detecting whether or not the shutter is opened, hopper detection sensor 173 indicating whether or not the hopper is correctly disposed, input portion 112 for inputting information, motor 123 for driving the rotor to discharge a drug, display portion 111 for displaying how driving is performed, USB terminal 115 as an interface for outputting predetermined data, and controller 800 for receiving information from drug detection sensor 212, shutter detection sensor 129, hopper detection sensor 173, and input portion 112 and controlling motor 123, display portion 111, and USB terminal 115 based on the received information.

Shutter detection sensor 129 and hopper detection sensor 173 detect opened and closed states of the shutter and detect mounted and non-mounted states of the hopper. When the shutter is opened, or when the hopper is not mounted, controller 800 performs control so as not to start operation even when the start key is pressed. Depending on setting, counting of a drug may be started regardless of opened and closed states of the shutter.

Input portion 112 is provided with numerical keys, a start key, a stop key, a clear key, and a mode key. When the numerical keys are pushed, numbers are inputted. When the start key is pushed, operation is started. When the stop key is pushed, operation is suspended. When the clear key is pushed, cancellation of operation and reset of error are performed. When the mode key is pushed, switching of modes is performed. As the switching of modes, there are an all number retrieval mode and a predetermined number retrieval mode. In the all number retrieval mode, the number of all drugs in the cassette is counted. In the predetermined number retrieval mode, operation of retrieving only a predetermined number of drugs is performed.

Display portion (liquid crystal display portion) 111 displays the number of drugs, a cassette number, a message, and a rotation speed of the rotor. During the all number retrieval mode, the number of drugs is counted up from zero. During the predetermined number retrieval mode, the number of drugs is counted down from a predetermined number. Display of the rotation speed indicates any of H (high-speed), M (middle-speed), and L (low-speed).

At USB terminal 115, data associating a data output date, a cassette number, and the number of drugs can be outputted.

Controller 800 can change setting of the rotation speed of the rotor. The rotation speed of the rotor is displayed on display portion 111 as described above. The rotation speed of the rotor is a normal rotation speed of the rotor. The rotation speed of the rotor is not limited to the normal rotation speed, and it may include the reverse rotation speed. In any cases, controller 800 renders the reverse rotation speed of the rotor to be lower than the normal rotation speed.

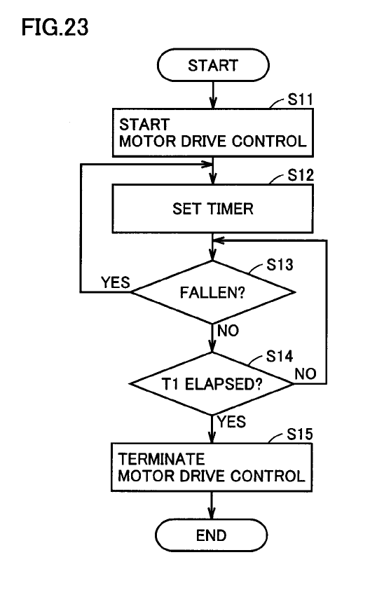

FIG. 23 is a flowchart representing drug retrieval operation of the drug retrieval device according to a first example. Firstly, in step S11 of FIG. 23, motor drive control is started. In step S12, a timer is set. In S13, determination is performed on whether or not a drug falls. When the drug falls (“YES” in step S13), the process returns to step S12. In step S13, when the drug does not fall (“NO” in step S13), determination is performed in step S14 on whether or not a time period T1 has elapsed. In this stage, time period T1 is twenty seconds, for example. In the case where time period T1 has not elapsed (“NO” in step S14), the process returns to step S13. In step S14, when time period T1 has elapsed (“YES” in step S14), the motor drive control is terminated in step S15.

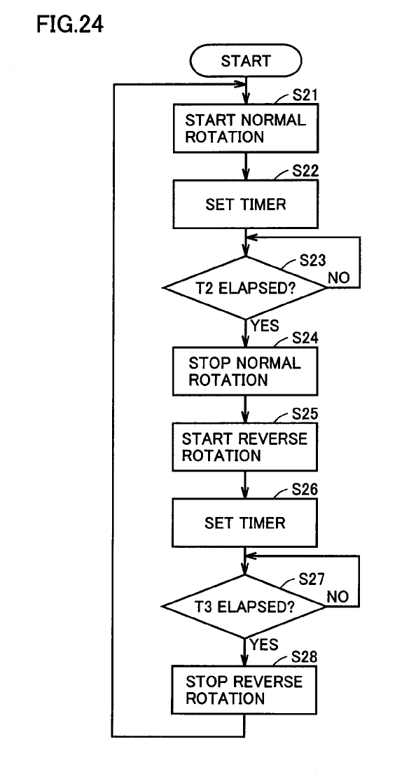

FIG. 24 is a flowchart representing a flow of allowing the rotor of the cassette to perform the normal rotation and the reverse rotation. The flow of FIG. 24 shows the motor drive control in detail. When the motor drive control is started in step S11 of FIG. 23, the normal rotation is started in step S21. Then, the timer is set in step S22. In step S23, determination is performed on whether or not a time period T2 has elapsed. When time period T2 has not elapsed in step S23 (“NO” in step S23), the process returns to step S23 again. In step S23, when time period T2 has elapsed (“YES” in step S23), the normal rotation is stopped in step S23. Then, the reverse rotation is started in step S23. In step S26, the timer is set. Time period T2 in step S23 is ten seconds, for example.

In step S27, determination is performed on whether or not a time period T3 has elapsed. Time period T3 is five seconds, for example. In the case where time period T3 has not elapsed in step S27 (“NO” in step S27), the process returns to step S27 again. When time period T3 has elapsed in step S27 (“YES” in step S27), the reverse rotation is stopped in step S28.

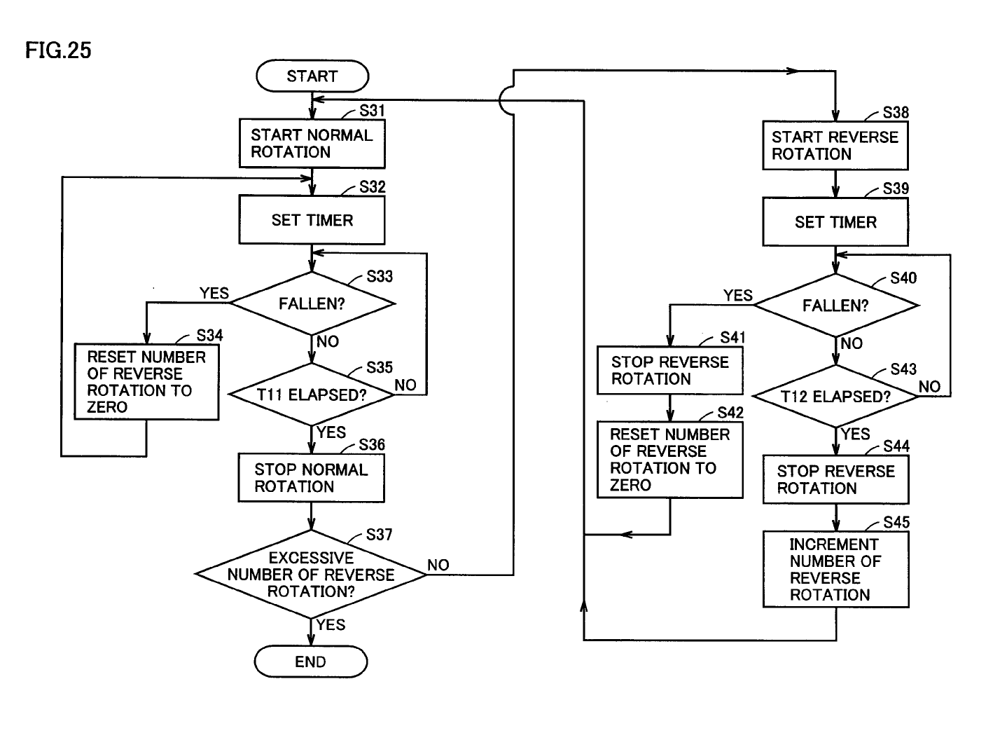

FIG. 25 is a flowchart representing drug retrieval operation of the drug retrieval device according to a second example. Referring to FIG. 25, in the second example, the normal rotation operation is started in step S31. Then, the timer is set in step S32. In step S33, when a drug falls from the cassette (“YES” in step S33), the number of reverse rotation is reset to zero in step S34. In step S33, when the drug has not fallen (“NO” in step S33), determination is performed in step S35 on whether or not a time period T11 has elapsed. As to time period T1, when the rotation speed of the rotor is high or middle (the case of H or M), time period T11 is three seconds. When the rotation speed of the rotor is low (L), time period T11 is five seconds. When time period T11 has not elapsed (“NO” in step S35), the process returns to step S33 again. When time period T11 has elapsed in step S35 (“YES” in step S35), the normal rotation is stopped in step S36. In step S34, determination is performed on whether or not the number of reverse rotation is excessive. When it is determined in step S36 that the number of reverse rotation is excessive (“YES” in step S37), the process is terminated. When the number of reverse rotation is not excessive in step S37 (“NO” in step S37), the reverse rotation is started in step S38. Then, the timer is set in step S39. In step S40, determination is performed on whether or not the drug has fallen. When the drug has fallen in step S40 (“YES” in step S40), reverse rotation is stopped in step S41. Then, in step S42, the number of reverse rotation is reset to be zero. Then, the process returns to step S31. In step S40, when the drug has not fallen (“NO” in step S40), determination is performed in step S43 on whether or not a time period T12 has elapsed. Time period T12 in step S43 is three seconds, for example. When time period T12 has not elapsed in step S43 (“NO” in step S43), the process returns to step S40. When time period T12 has elapsed in step S43 (“YES” in step S43), the reverse rotation is stopped in step S44. Then, the number of reverse rotation is incremented in step S45. In other words, the number of reverse rotation is increased by one. Then, the process returns to step S31.

Drug retrieval device 100 includes motor 123 as a rotation power source, torque limiter 131 for limiting transmission of torque when rotating force transmitted from motor 123 exceeds a predetermined value, and rotor 251 connected to torque limiter 131 to be rotatable and being capable of retrieving a drug by rotation, and rotor 251 is rotatable in the first rotation direction and the second rotation direction opposite to the first rotation direction.

Drug retrieval device 100 includes motor 123 and torque limiter 131 for limiting transmission of rotating force when rotating force transmitted from motor 123 exceeds a predetermined value. Torque limiter 131 is connected to rotor 251 capable of retrieving a drug by rotation, and rotor 251 is rotatable in the first rotation direction and the second rotation direction opposite to the first rotation direction.

Since torque limiter 131 is provided in drug retrieval device 100 with such a configuration described above, rotor 251 does not rotate when a rotation resistance of rotor 251 becomes greater due to clogging of a drug (tablet). Therefore, tight clogging of a drug can be prevented. Further, since rotor 251 is rotated in the reverse direction in the case of clogging, clogging of the drug can be resolved.

An appropriate rotation speed can be selected by changing the first and second rotation directions of rotor 251. By setting the normal rotation speed (the rotation speed in the first rotation direction) of a drug which is less likely to clog to be higher, the retrieval efficiency can be improved. By setting the normal rotation speed of a drug which is likely to clog to be low, the number of clogging can be reduced, thereby improving the retrieval efficiency.

The rotation speed in the first rotation direction may be higher than the rotation speed in the second rotation direction. In other words, the reverse rotation speed is lower than the normal rotation speed. In this case, a shock exerted to a clogged drug is reduced, so that damage to the drug can be prevented.

In the first example described above, rotor 251 is rotated in the first rotation direction for the first time period, and thereafter rotated to the second rotation direction for the second time period. In other words, controller 800 switches the normal rotation and the reverse rotation of the rotor according to time periods. In this case, clogging of a drug can be resolved with simple control.

In the second example, when a drug is not retrieved by rotation of rotor 251 in the first rotation direction, rotor 251 is rotated in the second rotation direction. In other words, controller 800 allows the rotor to perform the reverse rotation when the drug cannot be retrieved from the cassette with the normal rotation of the rotor. Since the reverse rotation is not performed when the drug does not clog, the retrieval efficiency can be improved. Torque limiter 131 may be provided in cassette 250.

It should be understood that the embodiments and examples disclosed herein are illustrative and non-restrictive in every respect. The scope of the present invention is defined by the terms of the claims, rather than the description of the embodiments set forth above, and is intended to include any modifications within the scope and meaning equivalent to the terms of the claims.

### REFERENCE SIGNS LIST

100 drug retrieval device; 111 display portion; 112 input portion; 113 key; 114 front panel; 115 terminal; 116 base; 117 power switch; 118 magnet; 119 hopper; 119a held portion; 119b detected part; 121 chute; 122 chute retaining portion; 123 motor; 124 circuit board; 125 shutter; 125a upper plate; 125b lower plate; 125c opening; 126 cassette guide; 126a insertion hole; 127a through hole; 128 detected portion; 129 shutter detection sensor; 131 torque limiter; 132, 133, 134, 221, 259 gear; 141 hinge; 148, 225 elongated hole; 171 hopper retaining member; 173 hopper detection sensor; 191 bolt; 192 shutter guide; 193 screw; 210 cassette base; 211 locking claw; 212 drug detection sensor; 222 guiding portion; 223 cassette retaining portion; 224 permanent magnet; 250 cassette; 251 rotor; 252 locked portion; 300 cover; 311 fuse; 313 adapter; 314 power supply; and 800 controller.

1. A drug retrieval device, comprising:
a rotation power source;
a torque limiter connected to said rotation power source to limit transmission of rotating force when the rotating force transmitted from said rotation power source exceeds a predetermined value; and
a rotor connected to said torque limiter to be rotatable and being capable of retrieving a drug by rotation, and
said rotor being rotatable in a first rotation direction and a second direction opposite to said first rotation direction.

2. A drug retrieval device, comprising:
a rotation power source; and
a torque limiter connected to said rotation power source to limit transmission of rotating force when the rotating force transmitted from said rotation power source exceeds a predetermined value, and
said torque limiter being connected to a rotor capable of retrieving a drug by rotation, and
said rotor being rotatable in a first rotation direction and a second rotation direction opposite to said first rotation direction.

3. The drug retrieval device according to claim 1, wherein a rotation speed of said rotor in said first direction or said second direction can be changed.

4. The drug retrieval device according to claim 1, wherein a rotation speed in said first rotation direction is higher than a rotation speed in said second rotation direction.

5. The drug retrieval device according to claim 1, wherein said rotor is rotated in said first rotation direction for a first time period, and thereafter rotated in said second rotation direction for a second time period.

6. The drug retrieval device according to claim 1, wherein when a drug is not retrieved by rotation of said rotor in said first rotation direction, said rotor is rotated in said second rotation direction.
